(19) United States
(12) Patent Application Publication
(10) Pub. No.: US 2023/0005059 A1
(43) Pub. Date: Jan. 5, 2023

(54) SYSTEM AND EXCHANGE FOR MANAGING RIGHTS OF PUBLICITY

(71) Applicant: Michael KLEIN, Miami, FL (US)

(72) Inventor: Michael KLEIN, Miami, FL (US)

(21) Appl. No.: 17/858,022

(22) Filed: Jul. 5, 2022

Related U.S. Application Data
(60) Provisional application No. 63/217,983, filed on Jul. 2, 2021.

(51) Int. Cl. G06Q 40/04; G06Q 20/12; G06Q 20/38; G06Q 20/40

(52) U.S. Cl. CPC G06Q 40/04; G06Q 20/1235; G06Q 20/3829; G06Q 20/3827; G06Q 20/40145; G06Q 2220/00

(57) ABSTRACT

A system and digital exchange for managing intangible personal rights includes at least a first and second object each including at least one object identifier, a first and second cryptographic object data block associated with the respective first and second objects, at least a first and second group of fractional cryptographic object data blocks each associated with the at least a first and second cryptographic object data block, and a digital exchange. The object data blocks and fractional data blocks contain a unique identifier and key associating the object data block with its respective object. Each data block is linked with a plurality of data blocks via cryptographic hashes. The digital exchange comprises a first user associated with an object data block, a first table including at least one object, object data blocks and fractional object data blocks, and a second user. The first user authorizes the transfer of at least one of an object data block and fractional object data block to the second user and an exchange transaction is created to verify and authenticate the transfer.

This application claims the benefit of U.S. Provisional Patent Application No. 63/217,983 filed Jul. 2, 2021, the entire contents of which are incorporated herein by reference.

### BACKGROUND

Rights of Publicity (“RoP”) are intangible legal rights that protect an individual's name, likeness, or other indicia of personal identity, such as a nickname, pseudonym, voice, signature, likeness, or photograph. Under state law throughout the United States, an individual can use his or her RoP for commercial benefit.

Typically, RoPs are licensed through sponsorship contracts. They inherently position RoPs at a disadvantage because of rigid contracting, a lack of true value evaluation, and access to a competitive open market. Long term contracts are cumbersome and lock-in individuals without the ability to fluctuate and adjust for growth of a person's brand based on market determinations.

The current RoP regime is even more challenging in a social media world with more avenues for creating a brand on the internet. A new generation of digital economy participants such as bloggers, influencers, gamers, online personalities, and upcoming athletes need ways to exploit their RoP in a more streamlined, transparent way. Moreover, with the changing online media landscape, traditional celebrities such as pro athletes, musicians, and businessmen need ways to digitize their RoPs more efficiently and in line with the changing media norms and technologies.

### SUMMARY OF THE DISCLOSURE

Accordingly, there is a need for a system and digital exchange for managing intangible personal rights. The system and exchange includes at least a first and second object each including at least one object identifier, a first and second cryptographic object data block associated with the respective first and second objects, at least a first and second group of fractional cryptographic object data blocks each associated with the at least a first and second cryptographic object data block, and a digital exchange. Each object data block contains a unique identifier and key associating the object data block with its respective object. Similarly, each fractional object data block contains a unique identifier and a key associating the fractional object data block with its respective object block and first or second object. The first and second cryptographic object data blocks are linked with a plurality of data blocks via cryptographic hashes. Similarly, each fractional object data block of a group is linked to another object data block of the same group via cryptographic hashes. Preferably, this includes a public distributed ledger and/or a private centralized or semi-centralized ledger.

The digital exchange comprises a first user associated with at least one of the object data block or fractional object data blocks, a first table including at least one of objects, object data blocks and fractional object data blocks, and a second user. When used, the first user authorizes the transfer of at least one of an object data block and fractional object data block to the second user and an exchange transaction is created to verify and authenticate the transfer. The exchange transaction is recorded with a chain of a plurality of data blocks which are linked via a cryptographic hash. Preferably, this includes a public distributed ledger and/or a private centralized or semi-centralized ledger.

In one embodiment, the object identifier includes at least one of an individual's name, image, likeness, nickname, pseudonym, voice, or signature. Further, the at least a first and second object each further include at least one attribute, wherein the at least one attribute is associated with the at least one object identifier. Preferably, the attribute includes at least one of an individual's age, gender, popularity rating, social media following, profession, awards, and experience in an industry.

In a second embodiment, the at least a first and second object each further include an adjustable object value, the object value being determined based on the at least one object identifier. Preferably, the object value adjusts based on weighting methods applied to one of the at least one object identifier and at least one attribute.

In another embodiment, the amount of cryptographic object data blocks associated with an object, and thus the amount of fractional cryptographic object data blocks, is determined according to an initial object value.

### BRIEF DESCRIPTION OF THE FIGURES

Other objects and advantages of the invention will become apparent from a study of the following description when viewed in the light of the accompanying drawing, in which:

FIG. 1 is a flow chart of a method for a system and exchange for managing intangible rights according to the present disclosure;

FIGS. 2 and 3 are schematics of the system and exchange of FIG. 1;

FIG. 4 is an embodiment of a login screen for a system and exchange according to the present disclosure;

FIG. 5 is an embodiment of a table showing exchangeable objects according to the present disclosure;

FIG. 6 is an embodiment of a table showing objects that have been exchanged according to the present disclosure;

FIG. 7 is an embodiment of a table showing objects associated with a user of an exchange according to the present disclosure; and

FIG. 8 is an embodiment of a table displaying the contents of a digital wallet according to the present disclosure.

### DETAILED DESCRIPTION

The exemplary embodiments are described below with reference to the drawings. These drawings illustrate details of embodiments that implement the modules, methods, and computer programs described disclosed. The methods and computer program product may be provided on any machine-readable media for accomplishing the described operations. The embodiments may be implemented using an existing computer processor, or by a special purpose computer processor incorporated for this or another purpose.

The embodiments described herein are implemented in a networked environment using logical connections to one or more remote computers having processors. These include commonplace computer networks, intranets and the internet and may use a wide variety of different communication protocols. The embodiments are implemented via distributed computing environments where tasks are performed by local and remote processing devices that are linked through a communication network. In a distributed computing environment, program modules may be located in both local and remote memory storage devices.

The embodiments of the disclosed system and exchange are implemented through general-purpose computing devices such as a computer that includes a processing unit, a system memory, and a system bus that connects system components including the memory to the processing unit. The computer and processor also includes machine-readable media, machine-executable instructions, data structures, program modules and other data for the computer.

The present disclosure provides a secure and verifiable way for an individual or entity to digitally manage RoPs through a digital system and exchange, which allows individuals to list, trade, sell and buy digital RoP rights. For the present system and exchange, those rights are handled via tokens with unique identifiers with the transfer and storage methods described herein to make the exchange of ownership in RoP easy and secure.

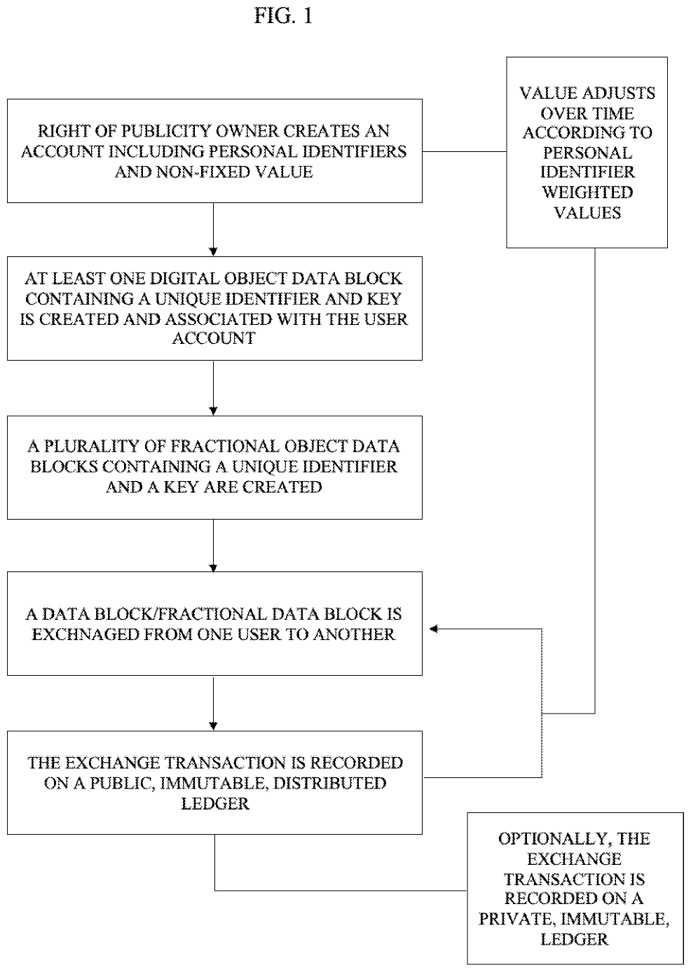

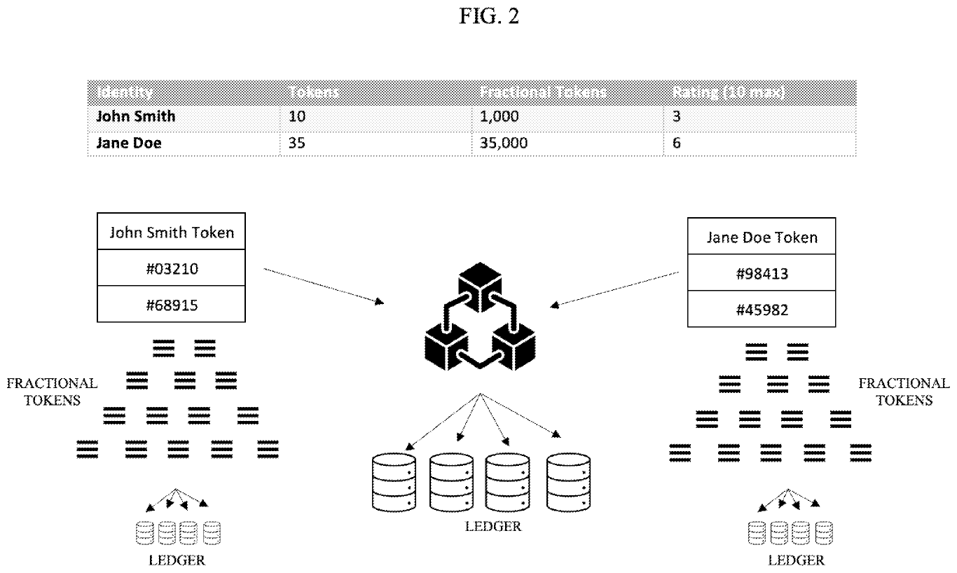

Referring to FIGS. 1-3, a method and schematic for a system and exchange are shown. A right of publicity owner, whether the public figure having the underlying rights or a person or entity that owns the underlying rights, creates an account that includes the rights. This is stored in the system as a first object with identifying attributes and an object value. The attribute includes at least one of an individual's age, gender, popularity rating, social media following, profession, awards, and experience in an industry. The object value is based on a value associated with the underlying right(s) of publicity, which continually adjust based on weighting methods applied to the underlying rights and attributes.

At least one token is created to represent the object and rights. The token includes a unique, cryptographic identifier and a key associating the token with the object. The token is then divided into a plurality of fractional tokens, each of which also include a unique, cryptographic identifier and a key associating the fractional token with the main token and the object. The unique identifier ensures that tokens and fractional tokens are secure and cannot be copied. The token and fractional tokens, also referred to as data blocks and fractional data blocks, are recorded with a public ledger that uses cryptographic hashes to secure the data blocks. The data blocks could also be recorded with a private ledger.

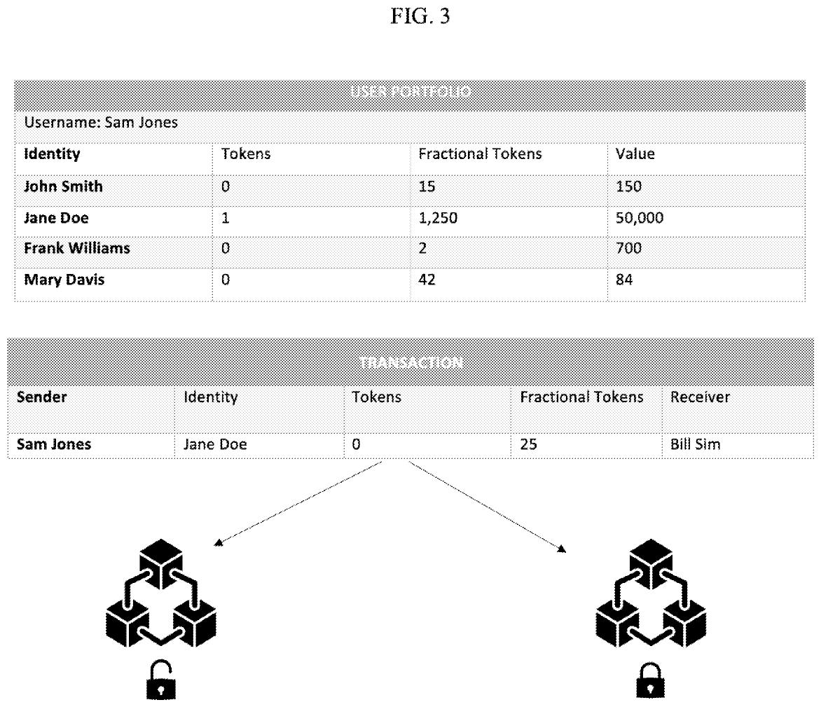

As shown in FIG. 3, once object and data blocks are created, they can be exchanged within the exchange and system. Then once exchanged, they can be further exchanged as desired by the owner of the data blocks. The exchange includes a first user associated with at least one of the data blocks or fractional data blocks, a first table including object information, object data blocks and fractional object data blocks, and a second user. The first user authorizes the transfer of tokens or fractional tokens to the second user and an exchange transaction is created to verify and authenticate the transfer. The exchange transaction is recorded with a chain of a plurality of data blocks which are linked via a cryptographic hash. Preferably, this includes a public, immutable, distributed digital ledger. A private ledger may also be used by a system and exchange administrator to track transactions.

The object identifier may include one or more attributes that records an individual's name, image, likeness, nickname, pseudonym, voice, or signature.

The amount of cryptographic object data blocks associated with an object, and thus the amount of fractional cryptographic object data blocks, is determined according to an initial object value.

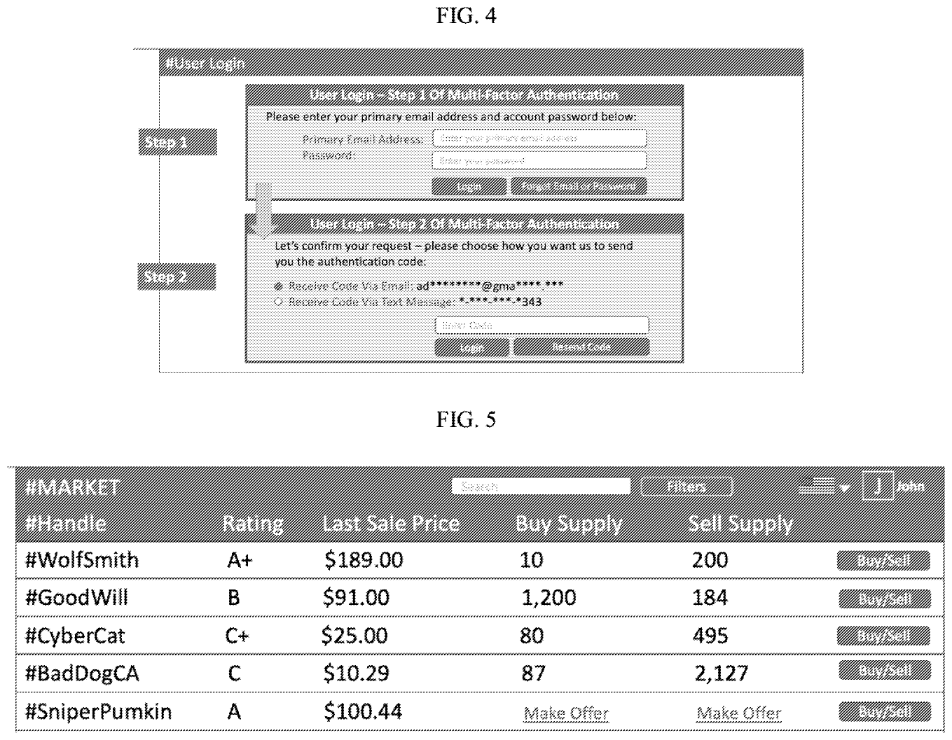

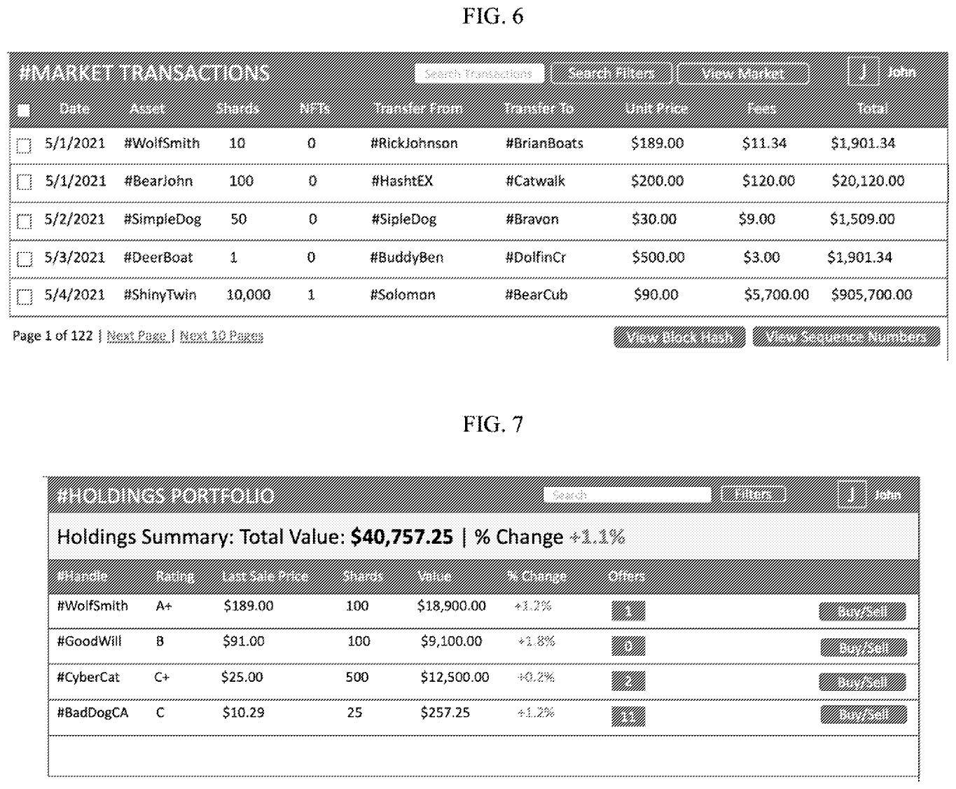

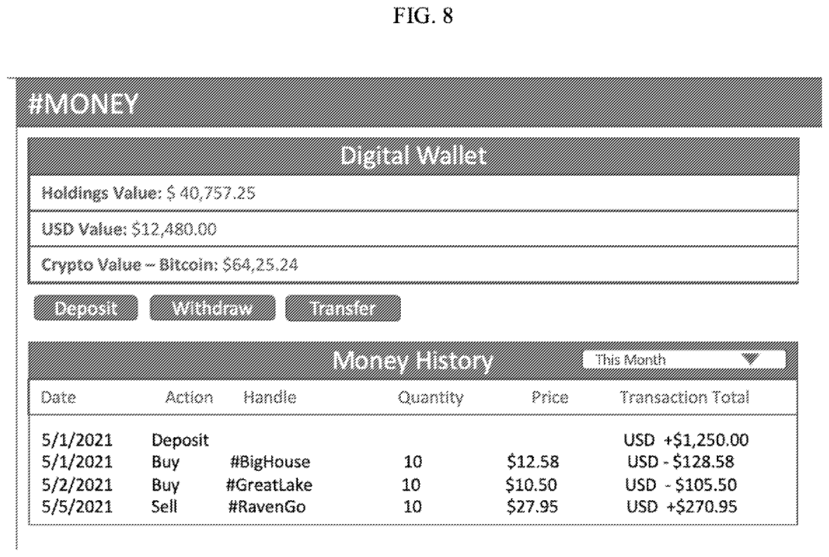

As shown in FIGS. 4-8, an individual manages his or her RoP for the present system and exchange by creating a system profile and obtaining tokens and fractional tokens within the exchange, the number of which are determined by a value of an individual's RoP. The tokens are purchased by other system users and/or granted to users by individuals in which the RoP resides, by system administrators, or by a token/fractional token owner. Artificial intelligence is used to streamline the process and connect potential sellers with buyers.

The tokens and fractional tokens ensure security in the creation and exchange of RoP digital rights, which are exchanged and recorded through a decentralized, distributed, digital, immutable ledger, such as with blockchain technology. Using such technology will allow for ease of valuation and fluctuation in the market value of the RoP of an individual, while also ensuring the tokens associated with that RoP are secure. Without such technology, a digital RoP exchange would be significantly more challenging to implement.

An individual lists his or her brand on the exchange if the individual (Right of Publicity Owner or RPO) meets certain eligibility criteria related to authenticating his or her identity and validating legal possession of the RoP. Once validated, the RPO is issued a user identifier, such as a hash handle, along with an initial system value and performance rating of the RoP. Preferably, the value and performance rating are computed via a system processor and algorithm which weighs factors relevant to the expected market value of the RoP. Previous initial valuations within the digital system and exchange, token exchanges and changes to valuation, in addition to specific attributes of the RPO are analyzed and compared via the algorithm to determine an initial value. It will be understood by those will skill in the art that other parameters relevant to rights of publicity generally and the RPO specifically could be considered. There is also a risk rating for each RPO, which is determined via similar means by system algorithms, and which may fluctuate throughout the listing and exchange of the RoP. The exchange maintains the rating throughout the life of a listing.

In one example, the exchange may assign 1,000 unique tokens to an RPO, each of which is split into 10,000 fractional tokens to represent the total of the digital RoP available for the exchange. This may represent 50% of the RoP value at the time of listing. To ensure the tokens are not overly diluted, there is a cap to the total number of tokens created for each RoP listed on the exchange.

Of the assigned tokens and fractional tokens, there is preferably a percentage that is maintained by the digital system and exchange for managing the transactions within the exchange. For instance, of the above noted 1,000 tokens with 10,000 fractional tokens each, totaling 10,000,000 fractional tokens, 50,000 such fractional tokens may be reserved for the digital system and exchange. Beyond this initial reservation, it is expected that the exchange will retain no further fractional tokens, thus providing ease of exchange between users.

The exchange ensures authenticity of ownership. All ownership certificate transactions are hosted directly by the exchange, and each token trade is recorded for ownership validation. In addition to a public ledger which can be accessed by all users to track and verify transactions, trades are tracked and recorded on a private ledger which can be viewed by administrators of the digital system and exchange.

Preferably, the RoP tokens and fractional token values are represented by a monetary value, such as the US Dollar, other similar territorial values, cryptocurrencies, or other such currencies. Ethereum is preferred technology used to track and value the tokens and fractional tokens, but it will be understood by those with skill in the art that alternative technologies and values could be attributed to the tokens and fractional tokens without deviating from the spirit of the invention.

Once the value and performance rating are determined, the fractional tokens are listed on the exchange for users of the exchange to obtain. Users can use digital currency and/or previously purchased fractional tokens to purchase new fractional tokens or exchange owned fractional tokens with new ones, respectively. Purchase of fractional tokens can be authorized by the RPO, authorized by system administrators, or automatically reviewed and authorized via a system processor and program with computer readable instructions. Once a purchase is made, the purchaser's digital wallet and fractional token ownership will be updated to reflect the change. The purchaser now has a fractional token that is valued by the RoP value of the RPO which may increase in value based on the RPO's growth in his or her industry. If a fractional token owner no longer wishes to own certain RoP fractional tokens, the owner can sell or exchange them through the secure ledger, ensuring transactional security for the new owner of the fractional token and for the RPO.

The digital system and exchange manages all transactions between users related to the exchange trade order flow, including buy, sell and offer automation, through automated artificial intelligence processes. Preferably, artificial intelligence programs identify supply and demand gaps to facilitate matching buyers and sellers.

This digital system and exchange determines the value of a Rights of Publicity Owners by allowing the owner to digitize his or her brand and enable open market RoP trading to increase value and awareness, unlock brand potential, and ultimately monetize one's own RoP.

Such a system will allow for more individuals who, until now, could not capitalize on their RoP to do so, it will allow for third parties to participate in the exchange and monetization of RoPs, and it will streamline the entire RoP monetization process that has followed an outdated model.

Although the above description is in reference to a particular embodiment, it is to be understood that the embodiment is merely illustrative of the principles and applications of the present disclosure. It is therefore to be understood that numerous modifications may be made to the illustrative embodiment and that other arrangements may be devised and employed without departing from the spirit and scope of the present disclosure.

What is claimed is:

1. A system and digital exchange for managing intangible personal rights, comprising:
(a) at least a first and second object each including at least one object identifier;
(b) at least a first and second cryptographic object data block associated with the respective at least a first and second objects, each object data block containing a unique identifier and key associating the object data block with its respective object, wherein the at least a first and second cryptographic object data blocks are linked with a plurality of data blocks via cryptographic hashes;
(c) at least a first and second group of fractional cryptographic object data blocks each associated with the at least a first and second cryptographic object data block, each fractional object data block containing a unique identifier and a key associating the fractional object data block with its respect first or second object, each fractional object data block of a group being linking to another object data block of the same group via cryptographic hashes; and
(d) A digital exchange, comprising:
(i) a first user associated with at least one of the fractional cryptographic object data blocks from the at least a first and second group;
(ii) a first table including at least one of objects, object data blocks and fractional object data blocks associated with the first user; and
(iii) a second user, wherein:
(1) the first user authorizes the transfer of at least one of an object data block and fractional object data block to the second user;
(2) an exchange transaction is created to verify and authenticate the transfer; and
(3) the exchange transaction is recorded with a chain of a plurality of data blocks, the plurality of data blocks linked via a cryptographic hash.

2. The system and digital exchange of claim 1, wherein the object identifier includes at least one of an individual's name, image, likeness, nickname, pseudonym, voice, or signature.

3. The system and digital exchange of claim 1, the at least a first and second object each further including at least one attribute, wherein the at least one attribute is associated with the at least on object identifier.

4. The system and digital exchange of claim 3, wherein the at least one attribute includes at least one of an individual's age, gender, popularity rating, social media following, profession, awards, and experience in an industry.

5. The system and digital exchange of claim 4, the at least a first and second object each further including an adjustable object value, the object value being determined based on the at least one object identifier.

6. The system and digital exchange of claim 5, wherein the object value adjusts based on weighting methods applied to one of the at least one object identifier and at least one attribute.

7. The system and digital exchange of claim 5, wherein the amount of cryptographic object data blocks associated with an object is determined according to an initial object value.

8. The system and digital exchange of claim 7, wherein the amount of fractional cryptographic object data blocks associated with a cryptographic object data block is determined according to the initial object value.

9. The system and digital exchange of claim 1, wherein the exchange transaction is recorded with a public, immutable, distributed ledger.

10. The system and digital exchange of claim 7, wherein the exchange transaction is recorded with a private cryptographic ledger.
